(19) United States
(12) Patent Application Publication
(10) Pub. No.: US 2006/0279731 A1
(43) Pub. Date: Dec. 14, 2006

(54) Process and device for determining the quality of a weld seam or a thermal spray coating and application

(75) Inventors: Eckhard Beyer, Dresden (DE); Jorg Hoschele, Meckenbeuren-Brochenzell (DE); Steffen Nowotny, Radebeul (DE); Alexander Ohnesorge, Immenstaad (DE); Jurgen Steinwandel, Uhldingen-Muhlhofen (DE)

Correspondence Address: AKERMAN SENTERFITT, P.O. BOX 3188, WEST PALM BEACH, FL, 33402-3188, US

(73) Assignees: DaimlerChrysler AG; Fraunhofer-Gesellschaft

(21) Appl. No.: 11/451,690

(22) Filed: Jun. 13, 2006

(30) Foreign Application Priority Data
Jun. 13, 2005 (DE) 102005027260.6-52

(51) Int. Cl. G01J 3/30; G01J 3/28

(52) U.S. Cl. 356/318; 356/326

(57) ABSTRACT

In material depositing processes such as welding or thermal spraying the large variety of processes and material parameters necessitate a broad range of the resulting characteristics of the applied material. The task of the present invention is comprised of providing a process and a device for determining the quality of specific layer characteristics, in particular their adhesion or strength of joining to the base material. This task is solved thereby, that as the quality characteristic there is employed the degree of mixing of the applied material with the base material.

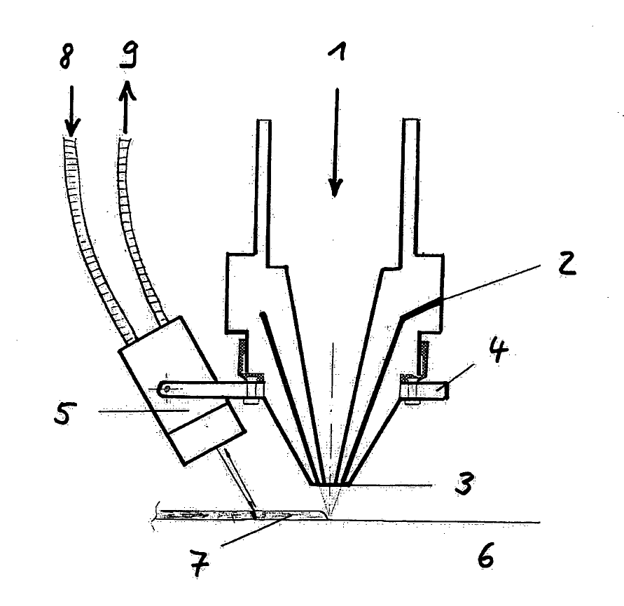

### BACKGROUND OF THE INVENTION

1. Field of the Invention

The invention concerns a process for determining the quality of a weld seam or a thermal spray coating layer as well as a corresponding device and applications thereof. A process of this generic type is already known from prior filed and subsequently published DE 102004004666 as well as DE 43 13 287 A1 or DE 33 44 683 A1.

2. Related Art of the Invention

In material depositing processes such as welding (in particular laser application welding) or thermal spraying the large variety of processes and material parameters necessitate a broad range of the resulting characteristics of the applied material. Known processes for quality determination include X-ray or eddy current testing, by means of which defects such as pores or inclusions can be determined. As further quality criteria in accordance to DE 43 13 287 A1 the depth of the welded is determined by spectral analysis of two ion lines of a characteristic element. An Echelle-spectrometer is disclosed in DE 199 00 308 A1. The production of surface plasma and the spectral analysis thereof is known from DE 43 41 462 A1 or DE 37 18 672 A1.

These processes are however only limitedly suited to quality determination of specific layer characteristics, in particular their adhesion to the base material.

### SUMMARY OF THE INVENTION

It is thus the task of the present invention to provide a process and a device for determining the quality of specific layer characteristics, in particular their adhesion to the base material, as well as their suitable applications.

With regard to the process and the device for quality determination as well as applications thereof, the invention is set forth in the Patent Claims. Further claims contain advantageous embodiments and further developments.

With regard to the process to be provided, the task is solved in that, as the quality characteristic, the degree of mixing of the applied material with the base material is utilized. The degree of mixing is a measure of the mixing-through of the applied material with a base material. Advantageous processes for determining the degree of mixing are set forth in the dependent claims.

The degree of mixing is, in comparison to the depth of welding, a substantially better criteria for determining layer characteristics, in particular their chemical characteristics and adhesion to the base material. In accordance with the invention this concerns basically a homogenous degree of mixing over the cross section of the applied material. Research under real conditions has shown that this assumption has been broadly justified. In-homogeneities of the mixing-through are of relevance or noticeable only in the case of exotic material combinations and extreme requirements of exactness. However, even in these cases, empirical correlations between the surface signals, the gradient of the degree of mixing, and quality characteristics can be determined, so that the inventive process can continue to be employed.

The degree of mixing can be determined by analysis of a specially produced plasma on the surface of the applied material.

For this, a LIPS sensor head (laser induced plasma spectroscopy) is connected to the work head, that is, it is secured (removably or variably exchangeably) thereto or is integrated therein. The LIPS sensor head is comprised of two concave mirrors, the adaptor pieces for the optical fibers, and their cladding. The laser pulse is guided by a first light guide or optical fiber to the sensor head and focused onto the probe via a first mirror. The plasma emissions, which are emitted into the space angle range of the second concave mirror, are focused thereby onto a second optical fiber and provided to the spectrometer.

The determination of the degree of mixing occurs by spectral analysis.

The spectral analysis occurs using an Echelle-spectrometer or alternatively by two-wavelength spectroscopy with interference filter and downstream amplifier unit, preferably a photo multiplier. In the case of the two-wavelength spectroscopy, it is not a large spectral range, but rather only the spectral lines designated for evaluation that are detected and examined with high time resolution. The detection of the lines occurs therein, for example, by application of a system comprised of interference filters and photo multipliers or a suitable spectrometer configuration (Czerny-Turner Spectrometer, etc.).

As disclosed above, we are concerned with an emission line of the analyte and an emission line of an internal standard. By determining the relationship or correlation of these measurement signals, one obtains the value to be consulted for evaluation. The selection of the two emission lines occurs generally by preliminary tests, in which, from a larger spectral range, detected for example with the aid of an Echelle spectrometer, suitable electronic transitions with the physical characteristics necessary for internal standardization are selected.

Echelle-spectrometers achieve a very high resolution in large spectral regions. Echelle-spectrometers are available are suitable for the most important spectral regions, and in particular in the visible, UV-, and IR-region.

One Echelle-spectrometer produces many spectra with high correlation numbers, which in part overlap. By means of a supplemental prism in the beam path the overlapping can be joined perpendicular to the direction of spreading of the first dispersive element (Echelle-grid), so that a two-dimensional image of spectral correlation results, which are provided superimposed or above each other in the exit side of the spectrometer. This image can be recorded by an electronic camera in the appropriate spectral region, of which the plurality of photosensitive individual sensors (preferably multiple mega-pixel) can then make possible the simultaneous detection of multiple thousand spectral lines.

The radiation to be analyzed is emitted from a surface plasma, which is induced by a short (few nanoseconds) energy impulse. The energy impulse can be transmitted in various modes and manners, for example by laser radiation or microwaves or by means of discharge arc or spark (arc or spark emission).

Therein, the material layer to be examined can be vaporized in a small area by sudden introduction of energy and be electronically excited, and thus a characteristic surface plasma can be induced. This type of plasma typically shows a “bremsstrahlung” (decelerated radiation) and recombination continuum. In order to effectively suppress this and be able to analyze the characteristic line spectra, the spectral analysis is set to occur after the introduction of energy, preferably with a delay of 50 to 300 ns, in particular 80 to 150 ns. This time delay ensures a reliable allocation or classification or correlation or mapping of the individual spectral lines, in particular in the higher Echelle orders (higher order harmonics).

The synchronization of energy input, for example laser pulse, and measurement with the spectrometer, can occur using conventional PC-control maps and trigger-generators.

A further improvement in the precision of the measurement results can be accomplished by time correlated measurement of the decay or dying out behavior. For this, an image amplifier is preferably employed, in particular a residual light image amplifier, in order to insure sufficient light intensity even in the case of small time separation, that is, high recording frequency.

In a further advantageous embodiment of the inventive process specific spectral lines are selected depending upon the base and applied material and supplied to the analysis, which are preferably already kept available in a data bank. The other detected spectral regions are discarded or disregarded and not analyzed. Thereby the analysis of the relevant spectrum is substantially accelerated, whereby a good online ability of the process results.

The task with regard to the device to be provided is inventively solved in that it includes a spectrometer, as well as a computer associated therewith, in which a first allocation or classification or mapping between characteristic spectral parameters and the degree of mixing of the applied material with the base material, and a second correlation between the degree of mixing and a quality scale, is stored.

The device further includes a unit for producing a surface plasma, which includes a LIPS sensor head as well as preferably a short pulse laser, and a device for adjusting a time delay between the production of the surface plasma and the spectral analysis by means of the spectrometer.

The inventive process and the inventive device are particularly suited for application in the motor vehicle industry, in particular in the production of land or air vehicles or their parts.

### BRIEF DESCRIPTION OF THE DRAWING

The Figure schematically shows a device for determining the quality a of a weld seam.

### DETAILED DESCRIPTION OF THE OF THE DRAWINGS

In the following the inventive process and the inventive device are described in greater detail on the basis of an illustrative embodiment:

Therein the device includes an Echelle-spectrometer, a LIPS sensor head, and a device for production of a short laser pulse, as well as a therewith associated computer, in which a first correlation between characteristic spectral parameters and the degree of mixing of the applied material with the base material, and a second correlation between the degree of mixing and a quality scale, is stored.

The Echelle-spectrometer includes an Echelle-gate for production of multiple spectrum (in the visible spectral region) with high order numbers, which in part overlap, as well as a supplemental prism, which is positioned in the beam path in such a manner that the overlaps join perpendicular to the degree of spreading of the Echelle-gate, so that a two-dimensional image of spectral arrangements or orders or regimes or organizations results, which are provided or associated on the emission plane of the spectrometer.

The processing head, with which the material is applied upon the substrate 6, is shown in the single Figure as a coaxial nozzle 3 with central guided work laser beam 1. The material to be applied is guided along one or more lines 2.

The degree of mixing of the applied material 4 is measured with the LIPS sensor head 5. The LIPS sensor head includes an inlet 8 for the short pulse sensor laser as well as a sensed signal output 9 to the detector. The LIPS sensor head 5 includes a mirror system comprised of two concave mirrors, one for deflection and focusing of the laser beam transmitted via the first optical fiber upon the sample, the other for collecting a part of the irradiated plasma emission and its focusing upon a second optical fiber, through which it is directed to the spectrometer.

This measurement signal (image) is recorded by an electronic camera in appropriate optical spectral regions, of which the large number of photosensitive individual sensors (8 mega-pixel) can then enable the simultaneous detection of multiple thousand of spectral lines.

The computer includes a control map and a trigger generator with which the vice for production of a short laser pulse and the electronic camera for recording the two-dimensional Echelle-spectra can be controlled and be synchronized with a time delay or offset of 100 ns. The time separation ensures the suppression of the typical bremsstrahlung and recombination continuum and ensures a reliable correlation of the individual spectral lines, in particular in the higher Echelle-orders.

In the computer a correlation equation between characteristic spectral parameters and the degree of mixing of the applied materials with the base material is stored and thereby easily accessible. The correlation equation is determined using exemplary layers-here using applied weld seams—for typical material systems, here: application of Stellite (Co-based alloy) —powder on ST37 steel samples by calibration/comparison with known measurement processes (analytic energy dispersive X-ray radiation (EDX), X-ray-fluorescents-analysis, . . .). Characteristic spectral parameters are produced here in particular in the Fe (I)- and Co (I)-lines, more specifically, in the spectral lines Fe(I) 394.4381 nm and Co(I) 402.3989 nm.

It is basically these relevant lines of the detected spectral regions that are supplied to the analysis, which thus occurs very rapidly (thus online-able) and at the same time very precisely.

The correlation equation between the degree of mixing and the quality scale with regard to the bonding behavior of the applied layer upon the base material as well as their chemical and mechanical characteristics are empirically determined by exemplary layers.

The inventive process and the inventive device have demonstrated themselves in the embodiment of the above described example as particularly suited for the quality determination of applied welding seams in the automobile and airplane industry (for example turbine blades).

In particular, thus, a significant improvement in substrate bonding and a defined mixing-through can be achieved, whereby the mechanical and chemical characteristics of the weld seam can be significantly improved.

The inventive process and the inventive device can be employed online during an ongoing welding process, and the degree of mixing of the welding seam or bead can be determined. This makes possible the follow-up control and optimizing of the welding seam during the process.

The described process is not limited to laser welding, but rather can be applied to any application process or energy supply, for example plasma or electron beam welding.

1. Process for determining the quality of a weld seam or a thermal spray coated layer, wherein the degree of mixing of the applied material with the base is employed as the quality characteristic, the process comprising:
inducing surface plasma by an energy impulse,
determining the degree of mixing by spectral analysis of the radiation emitted by surface plasma induced by an energy impulse using a spectrometer, wherein the spectral analysis is adjusted to occur subsequent to the energy impulse,
wherein a LIPS sensor head (laser induced plasma spectroscopy) is employed, which is connected with the processing head.

2. A process according to claim 1, wherein the spectral analysis occurs by means of an Echelle-spectroscopy or by means of two-wavelength spectroscopy by means of an interference filter, preferably with subsequent amplifier unit, in particular a photo multiplier.

3. A process according to claim 1, wherein the spectral analysis of at least two spectral regions of the radiation admitted by the location to be examined occurs.

4. A process according to claim 1, wherein the spectral analysis is time delayed to follow the energy impulse by 50 to 300 ns, in particular 80-150 ns.

5. Process according to claim 1, wherein, depending upon the base material and the applied material, specific spectral regions are selected, which are preferably maintained in a computer data bank, and provided for analysis.

6. A device for determining the quality of a weld seam or a thermal spray coated layer for carrying out a process for determining the quality of a weld seam or a thermal spray coated layer, wherein the degree of mixing of the applied material with the base is employed as the quality characteristic, the process comprising: (a) inducing surface plasma by an energy impulse, (b) determining the degree of mixing by spectral analysis of the radiation emitted by surface plasma induced by an energy impulse using a spectrometer, wherein the spectral analysis is adjusted to occur subsequent to the energy impulse, wherein a LIPS sensor head (laser induced plasma spectroscopy) is employed, which is connected with the processing head, comprising
a spectrometer,
a computer connected thereto, in which is stored:
a first correlation between spectral parameters and the degree of mixing of the material applied by the processing head with the base material, and
a second correlation between the degree of mixing and a quality skill,
a device for producing a surface plasma, and
a device for adjusting a time delay between the production of the surface plasma and the spectral analysis by means of the spectrometer, wherein the device for production of a surface plasma includes a LIPS sensor head, which is connected with the processing head.

7. A device according to claim 6, thereby characterized, that the device for production of a surface plasma includes a short pulse laser.

8. A process for manufacture of a vehicle, preferably in the production of automotive or aviation vehicles or their components, wherein the quality of a weld seam or a thermal spray coated layer is determined, and wherein the degree of mixing of the applied material with the base is employed as the quality characteristic, the process comprising:
inducing surface plasma by an energy impulse,
determining the degree of mixing by spectral analysis of the radiation emitted by surface plasma induced by an energy impulse using a spectrometer, wherein the spectral analysis is adjusted to occur subsequent to the energy impulse,
wherein a LIPS sensor head (laser induced plasma spectroscopy) is employed, which is connected with the processing head.
